(19) United States
(12) Patent Application Publication
(10) Pub. No.: US 2012/0145618 A1
(43) Pub. Date: Jun. 14, 2012

(54) GRAVITY FEED WATER TREATMENT SYSTEM WITH OXIDATION AND DISINFECTION STEPS

(75) Inventors: Roy W. Kuennen, Caledonia, MI (US); Kenneth E. Conrad, Ada, MI (US); William T. Stoner, JR., Ada, MI (US); Terry L. Lautzenheiser, Nunica, MI (US)

(73) Assignee: ACCESS BUSINESS GROUP INTERNATIONAL LLC, Ada, MI (US)

(21) Appl. No.: 12/965,453

(22) Filed: Dec. 10, 2010

(51) Int. Cl. C02F 1/76; C02F 1/68

(52) U.S. Cl. 210/199

(57) ABSTRACT

A portable water treatment system includes at least one sub-system to treat water including a primary disinfection system and a residual disinfection system. The water treatment system may include multiple sub-systems for treating water that feed into one another. The residual disinfectant may be administered to the water at a level below the taste threshold to prevent backgrowth of bacteria while leaving the taste of the water unaffected. The portable water treatment system may be designed to dispense water at a high-flow rate.

### BACKGROUND OF THE INVENTION

The present disclosure relates to water treatment systems, and in particular, to gravity feed water treatment systems.

As the world's population increases, the demand for water also increases. Indeed, in some parts of the world where the local population is growing at a much higher rate than average, the availability of safe drinking water may be relatively low. Some of this situation can be attributed to geography, whether from an arid climate or simply the lack of fresh surface water suitable for drinking. Additionally, many wellheads are running dry due to the lowering of underground aquifers, resulting in new wells being drilled to deeper depths, in an attempt to find water. In many cases, high costs prohibit these operations. Further, in many locales where water is very scarce, the population is unable to purchase water for consumption due to their low income levels and the fact that municipally treated water is unavailable. Examples of such settings may include rural villages in under-developed countries, disaster relief sites, or camp settings, to name a few.

Modern municipal water treatment systems, where available, are equipped to treat and distribute water for human consumption. In many cases, this treatment involves coagulation, flocculation and sedimentation of particulate matter. Additional filtering of the water may also be conducted, as well as treatment with chlorine. Three basic features of a water treatment system are sediment removal, chronic health risk abatement, and acute health risk abatement. Chronic health risks tend to be caused by chemical contamination of the water. Acute health risks tend to be caused by microbial contamination of the water.

When water is treated in a home beyond a municipal system (if one is available) the system is commonly referred to as a point-of-use (POU) system. These home POU systems use a variety of processes to treat water, such as: sediment filtration, reverse osmosis, carbon adsorption, deionization, softening, boiling, distillation and UV irradiation. Many POU systems include multiple steps of treatment, which are equipped to treat water with a high volume and variety of contaminants. In some cases, these POU systems are inappropriate for use because of unavailability of electric power, pressurized water or cost constraints. Many non-pressurized prior art systems also include slow flow rates at the outlet of the system, requiring users to wait at the water treatment system while the water makes its way through the system and out of the outlet.

Some prior art POU systems include treating the water with chlorine, which can create an offensive taste and odor for consumers. Other prior art POU systems have used bromine rather than chlorine in an attempt to solve these taste and odor issues associated with chlorine. However, the taste and odor of bromine may also be detectable to consumers when used in a concentration sufficient to disinfect water.

What is needed then is a water treatment system that addresses the three basic features of a water treatment system and is easy to use, does not require electric power or other energy sources, can be used in conjunction with an existing water treatment system or alone, and is easy to maintain. It is desirable for the system to be useful in a variety of applications, such as treating water for consumption in the home, disaster relief and outdoor activities. A water treatment system that is smaller and more portable would also be desirable. In addition, an increased flow rate at the outlet of the system and an improved taste and odor of the treated water would provide benefits for consumers.

### SUMMARY OF THE INVENTION

In one embodiment of the present disclosure, a water treatment system having a primary disinfection system is disclosed. Water enters an inlet, where the water is exposed to a primary disinfectant, such as chlorine, and enters the primary disinfection buffer. Besides chlorine, other materials capable of disinfecting the water may be used, such as other halogens, including but not limited to bromine and iodine. While the water is in the buffer with the chlorine, it is being disinfected. The water may pass through diffusers to help ensure even mixing of the chlorine solution. The water treatment system may include a primary disinfectant removal system, such as a dechlorination unit, to remove the primary disinfectant from the disinfected water. The primary disinfection buffer includes an outlet, which leads into a safe water storage tank. Water entering the safe water storage tank is exposed to a residual disinfectant that maintains the water at a desired disinfection level, for example, a disinfection level that is safe to consume. The residual disinfectant may be any halogen, including but not limited to bromine. The safe water storage tank includes an outlet, such as a spigot, through which the disinfected water exits the safe water storage tank.

In another embodiment, a high flow rate chlorination device may be used to control and/or increase the flow rate through the system. Other embodiments may include a flocculation step and/or a filtration step.

### BRIEF DESCRIPTION OF THE DRAWINGS

The disclosure may be better understood with reference to the drawings and following description. Non-limiting and non-exhaustive embodiments are described with reference to the following drawings. The components in the drawings are not necessarily to scale, emphasis instead being placed upon illustrating the principles of the invention.

FIG. 1 is a side view of an embodiment of the water treatment system;

FIG. 2 is a perspective view of an embodiment of a high flow rate chlorination device;

FIG. 3 is a cross sectional view of the high flow rate chlorination device of FIG. 2;

FIG. 4 is an exploded perspective view of the high flow rate chlorination device of FIG. 2;

FIG. 5 is an exploded cross sectional view of the high flow rate chlorination device of FIG. 2; and

FIG. 6 is a perspective view of an embodiment of a residual disinfectant delivery unit.

### DESCRIPTION OF THE CURRENT EMBODIMENTS

The POU water treatment system of the present disclosure is configurable for a variety of water conditions. The various components can be used singly or in various combinations to treat water for consumption or other uses. It is important to note that the configurations detailed below are exemplary and not exhaustive.

The illustration of the embodiments described herein are intended to provide a general understanding of the structure of the various embodiments. The illustration is not intended to serve as a complete description of all of the elements and features of the apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustration is merely representational and may not be drawn to scale. Certain proportions within the illustration may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although a specific embodiment has been illustrated and described herein, it should be appreciated that any subsequent arrangement designed to achieve the same or similar purpose may be substituted for the specific embodiment shown. This disclosure is intended to cover any and all subsequent adaptations or variations of various embodiments. Combinations of the above embodiments, and other embodiments not specifically described herein, will be apparent to those of skill in the art upon reviewing the description.

The disclosed subject matter is to be considered illustrative, and not restrictive. It will be apparent to those of ordinary skill in the art that many other embodiments and implementations are possible within the scope of the invention.

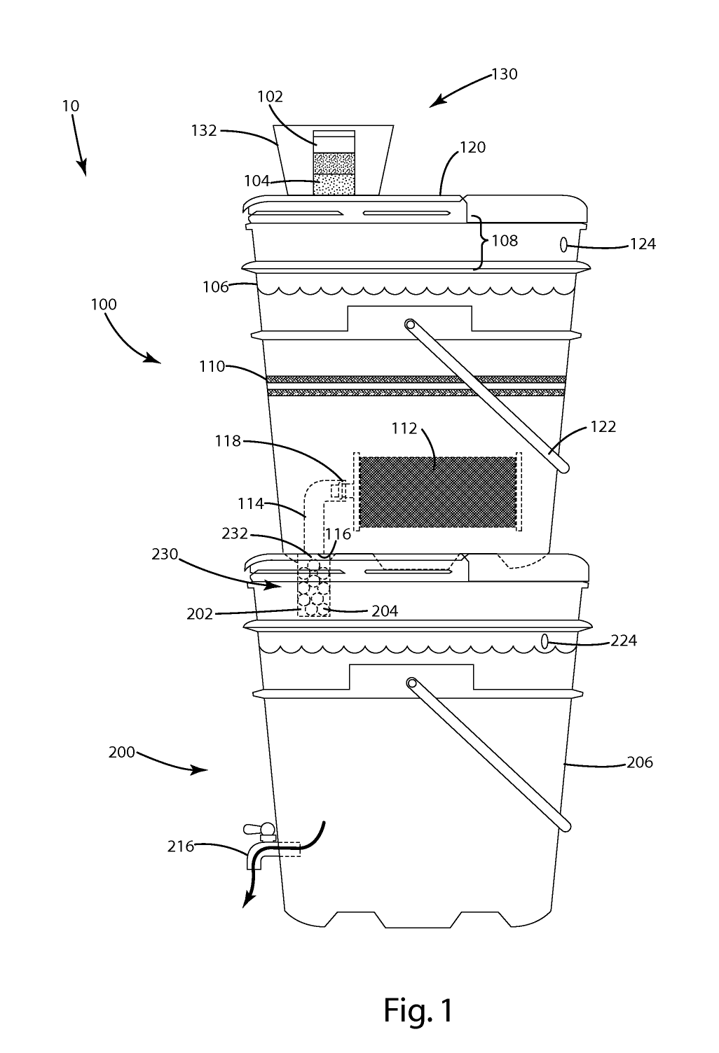

A POU gravity feed water treatment system constructed in accordance with at least one embodiment is shown in FIG. 1 and generally designated 10. The system 10 includes a primary disinfection system 100 and a residual disinfection or safe water storage system 200.

### I. Primary Disinfection System

Primary disinfection system 100 includes a primary disinfection inlet 132, a primary disinfection buffer or tank 106 and a primary disinfection outlet 116. Primary disinfection system 100 generally includes a primary disinfectant delivery system or unit 130 that adds a primary disinfectant to the water as water enters the system. As used in this application, a primary disinfectant is any disinfectant capable of disinfecting the water to be potable, meaning generally considered safe for human consumption. The system 100 may include essentially any disinfection system, for example, any of the chlorination systems disclosed in International Published Application PCT/US2010/020728 entitled “Gravity Feed Water Treatment System,” filed Dec. 29, 2009, which is incorporated herein by reference. In the current embodiment, chlorination purifies and disinfects the water by deactivating microorganisms which may reside in the water. Chlorine for water treatment can be obtained from a variety of sources, such as tri-chlorinated isocyanuric acid tablets commonly used in swimming pool applications, calcium hypochlorite, or di-chlorinated isocyanuric acid. Tri-chlorinated isocyanuric acid (CAS #87-90-1) is a stable vehicle for chlorine delivery to water. It provides a higher chlorine density (90% available chlorine) compared to the other types of chlorine mentioned due to the triple chlorination of the molecule. It is approved by NSF International for drinking water and is readily available. Other chlorine delivery options are also available, including liquid and powder chlorine dosing.

Primary disinfection system 100 generally includes a primary disinfection buffer or tank 106, a primary disinfectant or chlorination unit 130, a diffuser 110, a primary disinfectant removal system or dechlorination unit 112 and a primary disinfection outlet 116. The primary disinfection tank 106 of the illustrated embodiment is a bucket, such as a generally conventional plastic 5-gallon bucket. The bucket 106 may alternatively be essentially any other container or reservoir capable of storing the water as it is treated by the primary disinfectant including but not limited to a funnel or a pipe. If alternative sizes and shapes for the primary disinfection tank 106 are used, corresponding changes may be made to the primary disinfectant concentration and dwell time to produce sufficient disinfection of the water. The illustrated bucket 106 includes a handle 122 and a hinged lid 120. In the illustrated embodiment, the chlorination unit 130 includes a primary disinfection inlet 132, a chlorination capsule 102 and one or more chlorine tablets 104. In the illustrated embodiment, the system includes optional diffusers 110 that assist in mixing the chemical. The system may include a plurality of layers of diffusers 110. The dechlorination unit 112 may include a carbon filter, such as a pressed carbon block filter. For example, the eSpring carbon block filter available from Amway Corp. of Ada, Mich. may be used. The carbon block filter may also be replaced by other filters capable of sufficiently dechlorinating the water. The construction and manufacture of the dechlorination unit 112 is described below.

In the illustrated embodiment, the primary disinfection outlet 116 may be a free-flow spigot or any other free-flow opening capable of allowing water to flow freely out of the primary disinfection tank 106. The free-flow aspect of the primary disinfection outlet 116 ensures that the water is treated by the chlorine for the designed time period and is not over-treated. The primary disinfection outlet 116 may be defined in the wall or bottom of the tank 106 and may be coupled to the discharge of the dechlorinating unit 112, for example, by bushing 114 and O-ring 118. The primary disinfection outlet 116 may include a screen to prevent insects from entering the primary disinfection system 100.

Water to be treated, or water that has undergone treatment previously, such as flocculation and/or bio-sand filtration, enters primary disinfection inlet 132, which contains chlorine capsule 102, containing at least one chlorine tablet 104. Water is thus exposed to the chlorine in the tablets and chlorine is dissolved into the water, for example at 2-4 ppm (parts per million). It may be desirable to use water which has had some sort of particulant removal, such as flocculant or bio-sand filter treatment if treating low-grade water. This can prolong the life of the chlorine removal carbon filter by reducing clogging. If the system is treating mid to high-grade water, these extra treatment steps may not be necessary. It is noted that the water entering water treatment system 10 may be transferred to water treatment system 10 through virtually any means, including but not limited to pouring from a hand-held reservoir, pumping from a reservoir, gravity feeding from a reservoir, and pumping through a municipal or home plumbing system.

The chlorinated water then enters the primary disinfection tank 106, which may contain an air gap 108 for maintaining an acceptable level of chlorine and isocyanuric acid concentration in the water and may optionally also contain diffusers 110 which improve the mixing of the chlorinated water to a uniform solution. To maintain air gap 108, the primary disinfection tank 106 may include a primary disinfection overflow mechanism 124. For example, a drain hole 124 as shown in FIG. 1 may allow overflow water to exit the primary disinfection tank 106 when the water level in the primary disinfection tank 106 approaches the chlorination unit 130. Preventing the water level from rising into the chlorination unit 130 may prevent the water from being exposed to the chlorine tablet 104 for an unintended length of time, which otherwise could create chlorine levels in the water that are too high for the dechlorination unit 112 to completely remove and may affect the taste and odor of the water. Primary disinfection overflow mechanism 124 may also serve as an indicator to a user that the primary disinfection tank 106 is full and no more water should be poured into chlorination unit 130. Primary disinfection overflow mechanism 124 may also improve the flow of water through the primary disinfection tank 106 by allowing air to exit or enter the primary disinfection tank 106 during filling and emptying of the primary disinfection tank 106. Primary disinfection overflow mechanism 124 may include a screen for preventing insects from entering the primary disinfection tank 106.

The chlorinated water enters dechlorinating unit 112 and the chlorine is removed from the water as it passes through the dechlorinating unit 112. The dechlorination process ensures that the dispensed treated water does not have a chlorine taste, which may be undesirable to consumers. The dechlorinated water passes through bushing 114 to the primary disinfection outlet 116. The primary disinfection tank 106 may be accessed through a hinged or otherwise selectively closable lid 120 and transported with an optional carrying handle 122.

### II. Safe Water Storage System

Water exits the primary disinfection system 100 through the primary disinfection outlet 116 and flows into the safe water storage system 200. The safe water storage system 200 provides a temporary storage location for the chlorine-free water within the treatment system. The safe water storage system 200 provides a relatively high flow rate exiting the water treatment system 10 at the safe water storage outlet 216. The high flow rate is achieved by allowing water to exit the safe water storage system 200 without passing through a filter or other flow-impeding device adjacent the safe water storage outlet 216.

The safe water storage system 200 includes a residual disinfectant delivery system or unit 230, a safe water storage tank 206 and a safe water storage outlet 216. Residual disinfectant delivery unit 230 adds a residual disinfectant to the water as the water flows into the safe water storage system 200 that maintains the water at a desired disinfection level, for example, a disinfection level that is safe to consume. Even after chlorine treatment, as water sits in a water storage container, there is a potential for a back-growth of heterotrophic plate count (HPC) bacteria or other bacteria within the water. The dosing of residual disinfectant may eliminate HPC bacteria while remaining below the taste threshold, which is generally 0.2 parts per million (ppm). As used in this application, a residual disinfectant is any disinfectant capable of maintaining water that has been previously disinfected at a disinfection level that is at least safe to consume. Bromine or any other halogen may be used as a residual disinfectant.

Residual disinfectant delivery unit 230 includes a safe water storage inlet 232, a residual disinfectant capsule 202 and residual disinfectant 204. In the embodiment illustrated in FIG. 1, the residual disinfectant is in the form of one or more bromine beads 204, which are commercially available from HaloSource of Bothell, Wash. During use, water contacts the bromine beads 204 as it enters the safe water storage inlet 232, which causes bromine to rinse off the exterior of the bead and enter the water. The number of beads, size of the beads and/or concentration of bromine on the bead may be altered depending on flow rates and dosing requirements. Other residual disinfectant delivery options may also be used, including but not limited to liquid or powder dosing.

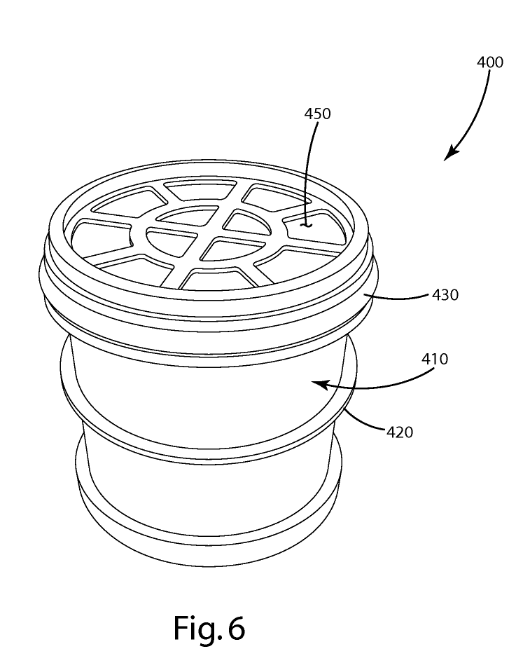

One embodiment of a bromine delivery device is shown in FIG. 6 and generally designated 400. The housing 410 of bromine delivery device 400 may include protrusions or ribs 420 that mate with safe water storage container 206 to produce a friction-fit, a snap-fit, or any other type of connection suitable to the application. An elastomeric ring 430 may provide a water-tight seal between the bromine delivery device 400 and the safe water storage container 206. The top of the housing 410 defines voids 450 that allow water to flow into the bromine delivery device 400. Within the housing 410, a porous material may secure the bromine beads within the bromine delivery device 400. The porous material may prevent the beads from escaping the device 400 while allowing water to flow through the material to contact the beads and produce proper bromine dosing. The bottom of housing 410 may include voids to allow water to pass out of the bromine delivery device 400 while retaining the porous material and bromine beads within the housing 410.

The bromine disinfects the water as the water is stored in the safe water storage tank 206. The safe water storage tank 206 may be various shapes and sizes, including a 5 liter or smaller bucket or a larger 10-15 liter container. In an alternate embodiment, the bromine beads may be in any location that provides contact with the water entering safe water storage tank 206, including but not limited to positioning the beads in a delivery unit within safe water storage tank 206 and positioning the beads loosely within safe water storage tank 206 so that they may move freely in safe water storage tank 206.

The safe water storage outlet 216 provides the user access to the treated water. The safe water storage outlet 216 may be any type of variable-flow valve capable of controlling the treated water flow exiting the safe water storage system 200, including a spigot or faucet. The safe water storage outlet 216 may be designed to provide the desired flow rate for the safe water storage system 200. The safe water storage outlet 216 may dispense water from the safe water storage tank 206 at a high flow rate, for example, greater than 2 liters per minute.

The safe water storage system 200 includes a safe water storage overflow device or mechanism 224 to allow air to exit or enter the safe water storage tank 206 during filling and emptying of the safe water storage tank 206. The safe water storage overflow mechanism may comprise a hole near the top of the safe water storage tank 206 with a screen for preventing insects from entering the safe water storage tank 206.

### III. Dechlorination Unit

The dechlorination unit 112 may be constructed of a filter media, such as activated carbon, and a polymer binder, such as polyethylene. The binder holds the block in shape but does not completely coat the surface of the media particles. The carbon particles are bonded together in the block by a high molecular weight or ultra-high molecular weight polyethylene. In one embodiment, the block composition is 80% to 90% carbon by weight and 10% to 20% binder by weight. In other embodiments, the composition may vary. The filter may be any of a variety of shapes and sizes depending on the specific size and flow requirements for the system. The surface of the filter may also be grooved to increase the surface area of the filter, thereby prolonging its useful life or prolonging the time span between cleanings.

The carbon filter of one embodiment may be manufactured using conventional manufacturing techniques and apparatus. One example of a carbon filter manufactured using conventional techniques and apparatus is disclosed in International Application No. PCT/US2010/020728, entitled “Gravity Feed Water Treatment System,” filed Jan. 12, 2010, which has been incorporated by reference above. In general, the binder (in powder form) and carbon are uniformly mixed so that the binder is uniformly dispersed throughout the carbon. In some embodiments, the binder is between about 10% to 20%, and in one particular embodiment about 12%, by weight based on the combined weight of the carbon and the binder. The combined carbon and binder are fed into a conventional mold having an upwardly projecting central dowel. The mold and its contents are then heated to from about 190 to about 235 degrees centigrade and most preferably about 204 degrees centigrade. Simultaneously, the combined carbon and binder are subjected to from about 100 to about 600 pounds of compression force, and preferably about 300 pounds, via a conventional pressure piston, which is lowered into the mold and which includes a central clearance opening for the central dowel. The combined carbon and binder are then permitted to cool and the resulting structure is removed from the mold in the form of an integrated carbon filter.

The filter may also include additives that enable the filter to remove heavy metals from the water. For example, an arsenic removal agent may be added to the filter to increase the filtration of arsenic. One example of an arsenic removal agent is Adedge Bayoxide® E33, which is commercially available from Adedge Technologies Inc. of Buford, Ga. Using a carbon filter with a chlorination step is especially effective because the chlorination step oxidizes the arsenic in the water from a +3 state to a +5 state. A carbon filter is more effective at removing arsenic at a +5 state than arsenic at a +3 state. A filter infused with an arsenic removal agent would further increase the ability of this type of filter to remove arsenic. Another example of an additive that may be added to the filter is a heavy metal removal agent, which increases the filtration of heavy metals. One example of a heavy metal removal agent is Metsorb HMRP, which is commercially available from Graver Technologies of Glasgow, Del. The additives may replace a portion of the carbon in the mixture described above. In one embodiment, the carbon block filter may include between 1-3% Metsorb HMRP and 20-30% Adedge Bayoxide® E33, by weight. The filter may also remove viruses, cysts, taste and odor, volatile organic compounds (VOCs), total trihalomethanes, pesticides, other heavy metals and other contaminants.

### IV. High Flow Rate Chlorination Device

As noted above, the water treatment system 10 may be used in areas in which the water is not potable, but does not require extensive filtration and disinfection. For example, water may be available from a municipal system, but not at a desired level of purity. In these locations, a user may desire more rapid water treatment. To facilitate a high flow rate, a high flow rate chlorination device may be used. Likewise, the dechlorination unit 112 and safe water storage outlet 216 may be designed to match or exceed the high flow rate of the high flow rate chlorination device.

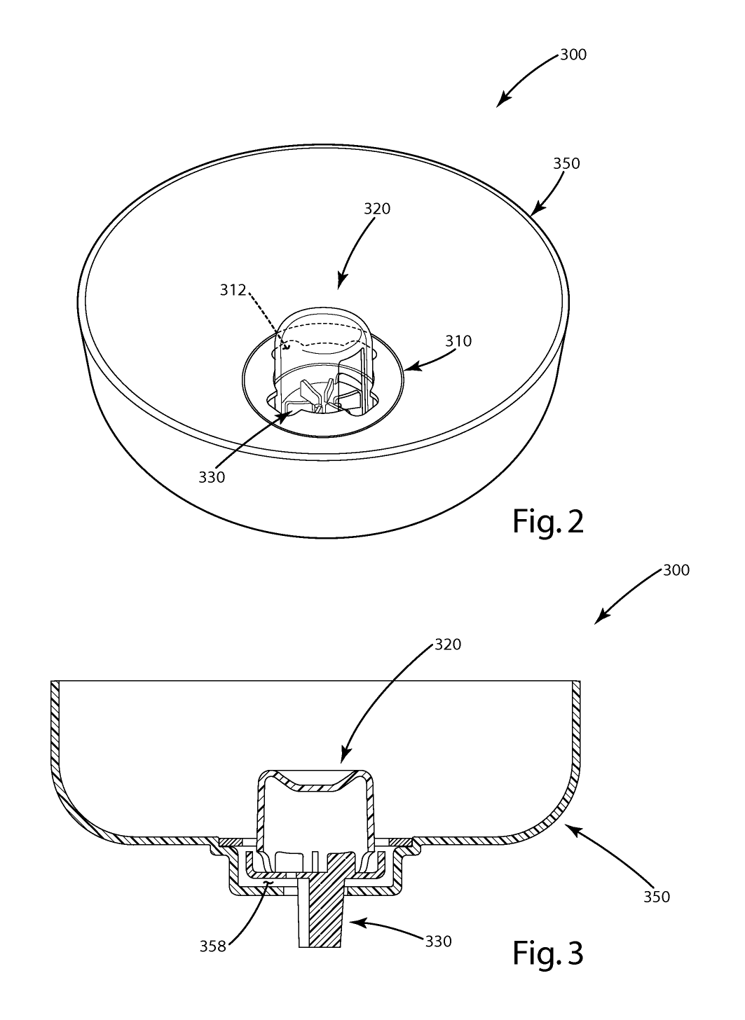

One embodiment of a high flow rate chlorination device is shown in FIGS. 2-5 and generally designated 300. The high flow rate chlorination device 300 may include a flow inlet plate 310, a cover 320, a flow director 330 and an inlet reservoir 350.

The flow inlet plate 310 may be a generally round piece of material, or may be any other shape suitable to the application. The interior edge of the flow inlet plate 310 defines one or more flow inlets 312, through which water may pass. The interior edge of the flow inlet plate 310 also defines at least one mating surface 314, which may mate with and engage the exterior surface of cover 320. The exterior edge 316 of the flow inlet plate 310 may mate with, engage or generally fit into inlet reservoir 350.

The cover 320 may be of sufficient size and of any shape capable of covering a chlorine delivery means, such as a chlorine tablet. The cover 320 defines at least one cover opening 322 through which water may enter and exit cover 320. The cover 320 may also include a locking tab 324 that fits with flow director 330 to secure cover 320 to flow director 330. The fit of locking tab 324 may be frictional, may include a snap-fit, or may include any other fitting means suitable to the application. The cover 320 may optionally be transparent so a user may visually determine when to replace the chlorine tablet.

The flow director 330 may generally receive cover 320 such that an upper surface of flow director 330 cooperates with cover 320 to further define cover openings 322. The flow director 330 may include one or more upper fins 332 that generally support the chlorine tablet and allow water to interface with a bottom surface of the tablet. In the illustrated embodiment, the bottom surface of the tablet would be the surface of the tablet interfacing with upper fins 332. The upper fins 332 may also assist in directing the flow of water through the high flow rate chlorination device 300. The flow director 330 may include one or more lower fins 334 to further direct the flow of water out of the high flow rate chlorination device 300. As shown in FIG. 3, the lower fins 334 may engage inlet reservoir 350 to position flow director 330, cover 320 and flow inlet plate 310 relative to inlet reservoir 350.

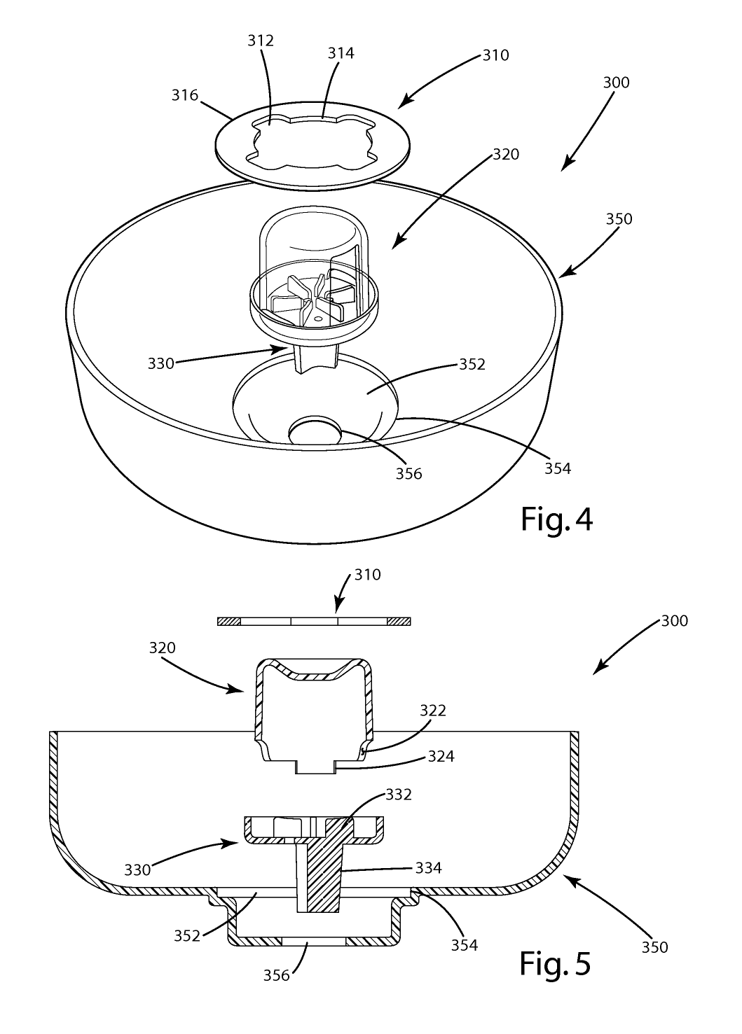

The inlet reservoir 350 generally receives water into the high flow rate chlorination device 300. In the illustrated embodiment, the inlet reservoir 350 includes a bowl-shaped surface, but inlet reservoir 350 may be any shape capable of receiving water. As shown in FIG. 4, inlet reservoir 350 may include a reservoir recess 352 defined by a reservoir edge 354 for receiving flow inlet plate 310, cover 320 and flow director 330. More specifically, reservoir edge 354 may mate with and engage flow inlet plate 310. The inlet reservoir 350 may also define a reservoir exit hole or aperture 356, which may engage or interface with lower fins 334 of flow director 330. The engagement between reservoir recess 352 and flow inlet plate 310, and the engagement between lower fins 334 and reservoir exit hole 356 generally support and position the flow director 330, cover 320 and flow inlet plate 310. As shown in FIG. 3, the flow director 330 and the inlet reservoir 350 define a reservoir exit channel 358, which leads to reservoir exit hole 356.

Suitable materials for the high flow rate chlorination device 300 will be apparent to those of ordinary skill in the art and include metals, plastics, composites and glass. To assemble the illustrated high flow rate chlorination device 300, cover 320 is frictionally fit to flow director 330. Flow inlet plate 310 may be slid onto cover 320 until mating surface 314 engages cover 320. The flow inlet plate 310, cover 320 and flow director 330 may be lowered within inlet reservoir 350, until the flow inlet plate 310 engages the reservoir edge and/or the lower fins 334 engage reservoir exit hole 356. These engagements may be adjusted to change the position of the flow inlet plate 310, cover 320 and flow director 330 relative to inlet reservoir 350. Changing the position of the flow inlet plate 310, cover 320 and flow director 330 relative to inlet reservoir 350 will change the size of reservoir exit channel 358 and may change the resulting flow rate through high flow rate chlorination device 300.

In use, water enters inlet reservoir 350 and is directed toward the flow inlets 312 at the middle of inlet reservoir 350. The water enters flow inlets 312 and some of the water is directed into cover 320 through cover openings 322, while the rest of the water is directed into reservoir exit channel 358 and bypasses the direct chlorine dosing. The percentage of water travelling in each of these directions may be adjusted by changing the size of reservoir exit channel 358, as described above. The water entering the reservoir exit channel 358 is directed through reservoir exit hole 356. The water entering cover 320 may mix with and contact the chlorine tablet positioned between upper fins 332 and cover 320. The water exits cover 320 through cover openings 322, enters reservoir exit channel 358 and exits reservoir 350 through reservoir exit hole 356. The mixing of the water after exiting high flow rate chlorination device 300 may produce potable water through an averaging effect between the water that entered cover 320 and the water that bypassed cover 320.

The illustrated embodiment of a high flow rate chlorination device 300 may produce a higher speed and more controlled flow of water than some prior art chlorination devices, which may be better adjusted in response to the grade of the incoming water and the resulting dosing requirements.

### V. Other Embodiments

Other water treatment mechanisms may be added to or used in conjunction with the above-described system. For example, if the water supply requires extensive filtration and disinfection, a flocculation step may be added before the primary disinfection system 100. There may also be a sediment removal step prior to the primary disinfection system 100.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A water treatment system comprising:
a primary disinfection buffer including a primary disinfection inlet defined by the primary disinfection buffer for receiving water into the primary disinfection buffer and a primary disinfection outlet defined in the primary disinfection buffer for dispensing the water from the primary disinfection buffer;
a primary disinfectant delivery system for delivering chlorine to the water;
a primary disinfectant removal system for removing the chlorine from the water;
a safe water storage tank connected to the primary disinfection tank including a safe water storage inlet defined by the safe water storage tank for receiving the water into the safe water storage tank and a safe water storage outlet defined by the safe water storage tank for dispensing the water from the safe water storage tank; and
a residual disinfectant delivery system separate from the primary disinfectant delivery system for delivering a residual disinfectant to the water.

2. The water treatment system of claim 1 including an overflow mechanism defined in the safe water storage tank.

3. The water treatment system of claim 1 wherein the primary disinfectant removal system includes a filter that includes at least one of an arsenic removal agent and a heavy metal removal agent.

4. The water treatment system of claim 3 wherein the filter has an outer surface and the outer surface defines at least one groove.

5. The water treatment system of claim 1 whereby the water in the safe water storage tank is disinfected and includes a concentration of residual disinfectant below the taste threshold.

6. The water treatment system of claim 1 wherein some of the water enters the cover housing the chlorine and some of the water bypasses the cover,
wherein the water is made potable through an averaging effect while the water is in the primary disinfection buffer.

7. A high flow rate water treatment system comprising:
a primary disinfection system including a primary disinfectant for disinfecting water and a filter for removing the primary disinfectant from the water;
a residual disinfection system including a residual disinfectant for maintaining the water at a desired disinfection level;
a free-flow outlet connecting the primary disinfection system and the residual disinfection system; and
a variable-flow outlet for dispensing water out of the high flow rate water treatment system.

8. The high flow rate water treatment system of claim 7 wherein the primary disinfection system includes a high flow rate chlorination device.

9. The high flow rate water treatment system of claim 7 wherein the filter includes at least one of an arsenic removal agent and a heavy metal removal agent.

10. The high flow rate water treatment system of claim 9 whereby the high flow rate water treatment system is capable of removing viruses, cysts, taste and odor, volatile organic compounds, total trihalomethanes, pesticides, lead and arsenic.

11. The high flow rate water treatment system of claim 10 wherein the filter has an outer surface and the outer surface defines at least one groove.

12. The high flow rate water treatment system of claim 7 wherein the residual disinfection system includes a residual disinfectant capsule for holding the residual disinfectant.

13. The high flow rate water treatment system of claim 12 wherein the residual disinfectant is bromine and the residual disinfectant is delivered to the water at a concentration below the taste threshold.

14. The high flow rate water treatment system of claim 13 wherein the residual disinfectant remains in the water when the water exits the water treatment system.

15. The high flow rate water treatment system of claim 7 wherein the primary disinfectant is in the form of a tablet and the primary disinfectant tablet is positioned to allow water to contact the primary disinfectant tablet from a bottom surface of the tablet.

16. A water treatment system comprising:
a primary disinfection flow path extending through a primary disinfection inlet, a primary disinfectant delivery unit, a primary disinfection buffer, a primary disinfectant removal unit and a primary disinfection outlet; and
a residual disinfection flow path downstream of the primary disinfection flow path and extending through a residual disinfection inlet, a residual disinfectant delivery unit, a residual disinfection tank and a residual disinfection outlet.

17. The water treatment system of claim 16 wherein the primary disinfectant delivery unit is adapted to deliver chlorine to water at a high flow rate.

18. The water treatment system of claim 16 wherein the residual disinfectant delivery unit is adapted to deliver bromine to the water.

19. The water treatment system of claim 16 wherein the primary disinfectant removal unit is a dechlorination unit that includes at least one of an arsenic removal agent and a heavy metal removal agent.

20. The water treatment system of claim 16 wherein the primary disinfectant removal unit has an outer surface and the outer surface defines at least one groove.
